(19) United States
(12) Patent Application Publication
(10) Pub. No.: US 2024/0078182 A1
(43) Pub. Date: Mar. 7, 2024

(54) PARALLEL PROCESSING WITH SWITCH BLOCK EXECUTION

(71) Applicant: Ascenium, Inc., Mountain View, CA (US)

(72) Inventor: Peter Foley, Los Altos Hills, CA (US)

(73) Assignee: Ascenium, Inc., Mountain View, CA (US)

(21) Appl. No.: 18/388,875

(22) Filed: Nov. 13, 2023

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/536,144, filed on Sep. 1, 2023.
(60) Provisional application No. 63/529,159, filed on Jul. 27, 2023.
(60) Provisional application No. 63/460,909, filed on Apr. 21, 2023.
(60) Provisional application No. 63/447,915, filed on Feb. 24, 2023.
(60) Provisional application No. 63/442,131, filed on Jan. 31, 2023.
(60) Provisional application No. 63/424,960, filed on Nov. 14, 2022.
(60) Provisional application No. 63/424,961, filed on Nov. 14, 2022.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 12/0842; G06F 12/0831

(52) U.S. Cl. CPC G06F 12/0842; G06F 12/0833

(57) ABSTRACT

Techniques for parallel processing based on parallel processing with switch block execution are disclosed. An array of compute elements is accessed. Each compute element within the array of compute elements is known to a compiler and is coupled to its neighboring compute elements within the array of compute elements. Control for the compute elements is provided on a cycle-by-cycle basis. Control is enabled by a stream of wide control words generated by the compiler. A plurality of compute elements is initialized within the array with a switch statement. The switch statement is mapped into a primitive operation in each element of the plurality of compute elements. The initializing is based on a control word from the stream of control words. Each of the primitive operations is executed in an architectural cycle. A result is returned for the switch statement. The returning is determined by a decision variable.

### RELATED APPLICATIONS

This application claims the benefit of U.S. provisional patent applications “Parallel Processing Using Hazard Detection And Mitigation” Ser. No. 63/424,960, filed Nov. 14, 2022, “Parallel Processing With Switch Block Execution” Ser. No. 63/424,961, filed Nov. 14, 2022, “Parallel Processing With Hazard Detection And Store Probes” Ser. No. 63/442,131, filed Jan. 31, 2023, “Parallel Processing Architecture For Branch Path Suppression” Ser. No. 63/447,915, filed Feb. 24, 2023, “Parallel Processing Hazard Mitigation Avoidance” Ser. No. 63/460,909, filed Apr. 21, 2023, “Parallel Processing Architecture With Block Move Support” Ser. No. 63/529,159, filed Jul. 27, 2023, and “Parallel Processing Architecture With Block Move Backpressure” Ser. No. 63/536,144, filed Sep. 1, 2023.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to parallel processing and more particularly to parallel processing with switch block execution.

### BACKGROUND

Data processing underlies the operations of organizations of all sizes. Whether commercial, governmental, medical, educational, research, or retail, the organizations rely on successful dataset processing. Indexing or retrieving particular pieces of data within the datasets is rendered difficult because the data is typically stored in an unstructured format, forcing the entire unstructured dataset to be processed in order to extract a single, critical data record. Organizational income and competitive advantage correlate with successful data processing, thus driving the organizations to annually expend substantial financial, human, and physical resources to achieve success. Failure to implement successful data processing is financially ruinous. Myriad sources provide the data for processing. The data is collected from various and diverse categories of individuals. The individuals include customers, citizens, patients, purchasers, students, test subjects, and volunteers, among many others. Some individuals willingly provide data, while others are unwitting subjects or even crime victims. Legitimate data collection techniques include “opt-in” strategies, where an individual signs up, creates an account, registers, or otherwise actively and willingly agrees to participate in the data collection. Other techniques are legislative, where citizens are required by a government to obtain a registration number to interact with government agencies, law enforcement, emergency services, and others. Some data collection techniques are more subtle or are intentionally concealed, such as tracking purchase histories, website visits, button clicks, and menu choices. Further techniques use fraudulent means to plant monitoring code to steal data. The collected data is highly valuable to the organizations that collect it, whatever techniques are used for the data collection.

### SUMMARY

Organizational goals, missions, and objectives are achieved by processing vast collections of data called datasets. The datasets are processed by submitting “processing jobs”, where the processing jobs load data from storage, manipulate the data using processors, and store the manipulated data to storage, among many other operations. The processing jobs are usually critical to the survival and flourishing of an organization. Common data processing jobs include generating invoices for accounts receivable; processing payments for accounts payable; running payroll for full time, part time, and contract employees; accounting for income and operational costs; analyzing research data; or training a neural network for machine learning. These processing jobs are based on tasks that are highly complex and computationally intensive. The tasks can include loading and storing various datasets, accessing processing elements and systems, executing data processing on the processing elements and systems, and so on. The tasks themselves include multiple steps or subtasks, which themselves can be highly complex. The subtasks can be used to handle specific jobs such as loading or reading certain datasets from storage, performing arithmetic and logical computations and other data manipulations, storing or writing the data back to storage, handling inter-subtask communication such as data transfer and control, and so on. The accessed datasets are vast and can easily saturate processing architectures that are either ill suited to the processing tasks or based on inflexible architectures. Instead, arrays of elements are used for processing the tasks and subtasks, thereby significantly improving task processing efficiency and throughput. The arrays include compute elements, multiplier elements, registers, caches, buffers, controllers, decompressors, arithmetic logic units (ALUs), storage elements, and other components which can communicate among themselves.

The array of elements is configured and operated by providing control to the array of elements on a cycle-by-cycle basis, where a cycle includes an architectural cycle. The control of the array is accomplished by providing control words generated by a compiler. The control words comprise one or more operations that are executed by the array elements. The control includes a stream of control words, where the control words can include wide control words generated by the compiler. The control words are used to initialize the array, to control the flow or transfer of data, and to manage the processing of the tasks and subtasks. The compiler provides static scheduling for the array of compute elements in order to configure the array. Further, the arrays can be configured in a topology which is best suited to the parallel processing. The topologies into which the arrays can be configured include a systolic, a vector, a cyclic, a spatial, a streaming, or a Very Long Instruction Word (VLIW) topology, among others. The topologies can include a topology that enables machine learning functionality. The control words can be compressed to reduce control word storage requirements. A plurality of compute elements within the array of compute elements is initialized with a switch statement. The switch statement comprises an expression, such as a control expression based on a decision variable, and cases, each of which may be associated with a block of one or more lines of code. The case that is chosen for execution is based on evaluation of the control expression. The switch statement can also include a default “case”, which is executed if none of the cases match the result of the control expression. The switch statement is mapped into primitive operations in each element of the plurality of compute elements. The operations include arithmetic, logical, and data transfer operations, etc. The initializing is based on a control word from the stream of control words. The primitive operations are executed in parallel within a cycle such as an architectural cycle. A result of the switch statement is evaluated, based on the decision variable, which determines the actual switch block that gets executed.

Memory access operations associated with the control words are tagged with precedence information. The tagging is contained in the control words; the initial tagging is provided by the compiler at compile time and updated with runtime precedence information. Memory access operations are monitored based on the precedence information and a number of architectural cycles of the cycle-by-cycle basis. The monitoring is performed to track progress of memory access operations because memory access time is unknown to the compiler. Further, the time to transfer the data, where the transfer can include data transiting a crossbar switch, is also unknown to the compiler. The tagging is augmented at run time, based on the monitoring. The data that is accessed can be held in access buffers prior to promotion, based on the monitoring. The holding enables identifying hazardous loads and stores by comparing load and store addresses, along with the precedence information, to contents of other memory accesses held in an access buffer.

Parallel processing is accomplished based on parallel processing with switch block execution. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. A plurality of compute elements within the array of compute elements is initialized with a switch statement, wherein the switch statement is mapped into a primitive operation in each element of the plurality of compute elements, and wherein the initializing is based on a control word from the stream of control words. Each of the primitive operations is executed in an architectural cycle. A result is returned for the switch statement, wherein the returning is determined by a decision variable.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for parallel processing with switch block execution.

FIG. 2 is a flow diagram for decision variable handling.

FIG. 3 is an infographic showing spatial mapping of switch block function.

FIG. 4 is an infographic that illustrates spatial and temporal mapping.

FIG. 5 is a system block diagram for a highly parallel architecture with a shallow pipeline.

FIG. 6 illustrates compute element array detail.

FIG. 7 is a system block diagram for compiler interactions.

FIG. 8 is a system diagram for parallel processing with switch block execution.

### DETAILED DESCRIPTION

Techniques for parallel processing with switch block execution are disclosed. High-level programming languages, such a C or C++, support a switch statement. A switch statement includes an expression such as a control expression, cases, and a default. Each case can comprise an if, else if, and else construct that can perform tasks such as a data load, a data operation, a data store, a function call, and so on. Whichever case is evaluated to be true causes the switch block code associated with that case to be executed. A plurality of compute elements within an array of compute elements can be initialized with the switch statement. The switch statement is mapped to a primitive operation of multiple elements of the plurality of compute elements. Multiple architectural cycles may be required to implement a single iteration of the switch statement. The mapping in each element of the plurality of compute elements comprises a spatially adjacent mapping. The spatially adjacent mapping can include an M×N subarray of the array of compute elements. The primitive operation can include an arithmetic, logical, or data operation, and so on. Each case associated with the switch statement can be executed substantially in parallel in one or more architectural cycles to produce a result. The architectural cycle is associated with the array of compute elements. The case result that is chosen for return is based on evaluation of the control expression. The result is provided by one of the plurality of compute elements.

Wide control words that are generated by a compiler are provided to the array. The wide control words are used to control elements within an array of compute elements on a cycle-by-cycle basis. A plurality of compute elements within the array of compute elements is initialized based on a control word from the stream of control words. The plurality of compute elements is organized to implement a switch statement. Each switch block comprising the switch statement, in addition to the case evaluation logic, is mapped into a primitive operation in each element of the plurality of compute elements. A primitive operation can include an arithmetic operation, a logical operation, a data handling operation, data movement between compute elements, and so on. The mapping in each element of the plurality of compute elements includes a spatially adjacent mapping. The spatial adjacency can include pairs and quads of compute elements, regions and quadrants of compute elements, and so on. The spatially adjacent mapping comprises an M×N subarray of the array of compute elements. The primitive operations associated with the switch statement can be mapped into some or all of the compute elements. Unmapped compute elements within the M×N array can be initialized for operations unassociated with the switch statement. The spatially adjacent mapping is determined at compile time by the compiler.

In order for tasks, subtasks, and so on to execute properly, particularly in a statically scheduled architecture such as an array of compute elements, one or more operations associated with the plurality of wide control words must be executed in a semantically correct operations order. That is, the memory access load and store operations associated with a switch statement and with other operations must occur in an order that supports the execution of the switch block, tasks, subtasks, and so on to conform to the in-order semantics of the switch statement of the high-level programming language. If the memory load and store operations do not occur in the proper order, then invalid data is loaded, stored, or processed. Another consequence of “out of order” memory access load and store operations is that the execution of the tasks, subtasks, etc., must be halted or suspended until valid data is available, thus increasing execution time. Tags can be associated with memory access operations to enable hardware ordering of memory access loads to the array of compute elements, and memory access stores from the array of compute elements. The loads and stores can be controlled locally, in hardware, by one or more control elements associated with or within the array of compute elements. The controlling in hardware is accomplished without compiler involvement beyond the compiler providing the plurality of control words that include precedence information. The precedence information includes intra-control word precedence and/or inter-control word precedence. The intra-control word precedence and/or inter-control word precedence can be used to locally schedule and control the memory access operations.

The loading data from memory includes accessing an address within memory and loading the contents into a load buffer, prior to loading the data for one or more compute elements within the array. Data can also be available without waiting for memory access because it is present due to an early load operation, a line buffer hit, or an access buffer hit. Similarly, storing data to memory includes placing the store data into an access buffer or directly into a level-zero data cache, also called a line buffer (described later). The load buffer and the access buffer can be used to hold data prior to loading into the array or storing into memory, respectively. The load buffer and the access buffer can accumulate data, retime loading data and storing of data transfers, and so on. Since the load operations and the store operations access one or more addresses in the memory, hazards can be identified by comparing load and store addresses. The identifying hazards can be based on memory access hazard conditions that include write-after-read, read-after-write, and write-after-write conflicts. Since the memory access data is stored in access buffers prior to being released or promoted to the memory, the identifying hazardous loads and stores can be accomplished by comparing load and store addresses to contents of an access buffer. The comparing can further include the precedence information. The hazards can be avoided by delaying the promoting of data to the access buffer and/or releasing data from the access buffer. The delaying can be based on one or more cycles. The identifying a hazard enables hazard mitigation. Since the load data or store data requested by a memory access operation may still reside in the access buffer, the requested data can be accessed in the access buffer using a forwarding technique. Thus, the hazard mitigation can include load-to-store forwarding, store-to-load forwarding, and store-to-store forwarding.

Data manipulations are performed on an array of compute elements. The compute elements within the array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage which can include local memory elements, register files, scratchpad storage, cache storage, etc. The cache, which can include a hierarchical cache, such as a level 1 (L1), a level 2 (L2), and a level 3 (L3) cache working together, can be used for storing data such as intermediate results, compressed control words, coalesced control words, decompressed control words, relevant portions of a control word, and the like. A line buffer, which holds the latest line(s) fetched out of the data cache (D$), can be considered a level 0 cache, and can be the same width as the L1 cache, typically 64 bytes. The cache can store data produced by a taken branch path, where the taken branch path is determined by a branch decision. The decompressed control word is used to control one or more compute elements within the array of compute elements. Multiple layers of the two-dimensional (2D) array of compute elements can be “stacked” to comprise a three-dimensional array of compute elements.

The tasks, subtasks, etc., that are associated with processing operations are generated by a compiler. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of wide control words on a cycle-by-cycle basis, where one or more control words are generated by the compiler. The control words can include wide microcode control words. The length of a microcode control word can be adjusted by compressing the control word. The compressing can be accomplished by recognizing situations where a compute element is unneeded by a task. Thus, control bits within the control word associated with the unneeded compute elements are not required for that compute element. Other compression techniques can also be applied. The control words can be used to route data, to set up operations to be performed by the compute elements, to idle individual compute elements or rows and/or columns of compute elements, etc. The compiled microcode control words associated with the compute elements are distributed to the compute elements. The compute elements are controlled by a control unit which decompresses the control words. The decompressed control words enable processing by the compute elements. The task processing is enabled by executing the one or more control words. In order to accelerate the execution of tasks, to reduce or eliminate stalling for the array of compute elements, and so on, copies of data can be broadcast to a plurality of physical register files comprising 2R1 W memory elements. The register files can be distributed across the 2D array of compute elements.

Parallel processing is accomplished with switch block execution techniques. The cases and default(s) associated with a switch statement can be evaluated based on primitive compute element operations. The primitive operations can be executed in parallel. An array of compute elements is accessed. The compute elements can include computation elements, processors, or cores within an integrated circuit; processors or cores within an application specific integrated circuit (ASIC); cores programmed within a programmable device such as a field programmable gate array (FPGA); and so on. The compute elements can include homogeneous or heterogeneous processors. Each compute element within the array of compute elements is known to a compiler. The compiler, which can include a general-purpose compiler, a hardware-oriented compiler, or a compiler specific to the compute elements, can compile code for execution on the compute elements. Each compute element is coupled to its neighboring compute elements within the array of compute elements. The coupling of the compute elements enables data communication between and among compute elements. Thus, the compiler can control data flow between and among the compute elements and can also control data commitment to memory outside of the array.

Control for the compute elements is provided on a cycle-by-cycle basis. A cycle can include a clock cycle, an architectural cycle, a system cycle, etc. The control is enabled by a stream of wide control words generated by the compiler. The control words can configure compute elements within an array of compute elements. The control words can include one or more operations that can be executed by the compute elements, where the operations can include switch block execution operations. A plurality of compute elements within the array of compute elements is initialized with a switch statement. The switch block can be mapped into a primitive operation in each element of the plurality of compute elements. The initializing is based on a control word from the stream of control words. The stream of wide control words generated by the compiler provides direct, fine-grained control of the array of compute elements. The fine-grained control can include control of individual compute elements, memory elements, control elements, etc. Each of the primitive operations is executed, substantially in parallel, in an architectural cycle. A result for the switch statement is returned. The result that is returned is determined by a decision variable.

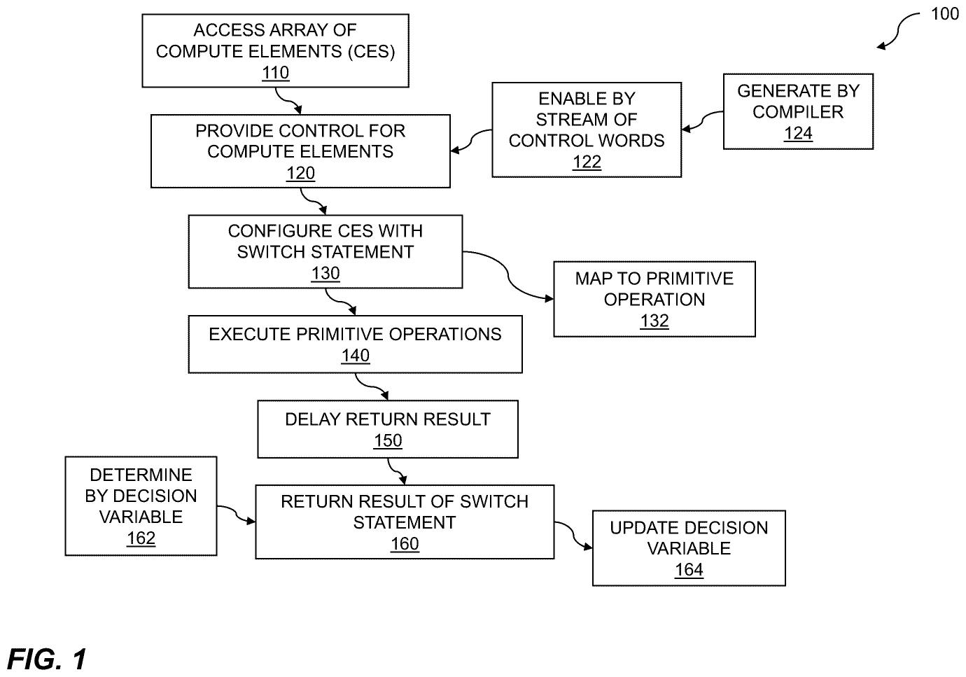

FIG. 1 is a flow diagram for parallel processing with switch block execution. Groupings of compute elements (CEs), such as CEs assembled within an array of CEs, can be configured to execute a variety of operations associated with data processing. The operations can be based on tasks, and on subtasks that are associated with the tasks. The array can further interface with other elements such as controllers, storage elements, ALUs, memory management units (MMUs), GPUs, multiplier elements, and so on. The operations can accomplish a variety of processing objectives such as application processing, data manipulation, data analysis, and so on. The operations can manipulate a variety of data types including integer, real, floating-point, and character data types; vectors and matrices; tensors; etc. Control is provided to the array of compute elements on a cycle-by-cycle basis, where the control is based on wide control words generated by a compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence data provision and compute element results. The control enables execution of a compiled program on the array of compute elements.

The flow 100 includes accessing an array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can be arranged in pairs, quads, and so on, and can share resources within the arrangement. The compute elements can include heterogeneous compute resources, where the heterogeneous compute resources may or may not be colocated within a single integrated circuit or chip. The compute elements can be configured in a topology, where the topology can be built into the array, programmed or configured within the array, etc. In embodiments, the array of compute elements is configured by a control word that can implement a topology. The topology that can be implemented can include one or more of a systolic, a vector, a cyclic, a spatial, a streaming, or a Very Long Instruction Word (VLIW) topology. In embodiments, the array of compute elements can include a two-dimensional (2D) array of compute elements. More than one 2D array of compute elements can be accessed. Two or more arrays of compute elements can be colocated on an integrated circuit or chip, on multiple chips, and the like. In embodiments, two or more arrays of compute elements can be stacked to form a three-dimensional (3D) array. The stacking of the arrays of compute elements can be accomplished using a variety of techniques. In embodiments, the three-dimensional (3D) array can be physically stacked. The 3D array can comprise a 3D integrated circuit. In other embodiments, the three-dimensional array is logically stacked. The logical stacking can include configuring two or more arrays of compute elements to operate as if they were physically stacked.

The compute elements can further include a topology suited to machine learning computation. A topology for machine learning can include supervised learning, unsupervised learning, reinforcement learning, and other machine learning topologies. A topology for machine learning can include an artificial neural network topology. The compute elements can be coupled to other elements within the array of CEs. In embodiments, the coupling of the compute elements can enable one or more further topologies. The other elements to which the CEs can be coupled can include storage elements such as a scratchpad memory, one or more levels of cache storage, control units, multiplier units, address generator units for generating load (LD) and store (ST) addresses, buffers, register files, and so on. The compiler to which each compute element is known can include a C, C++, or Python compiler. The compiler to which each compute element is known can include a compiler written especially for the array of compute elements. The coupling of each CE to its neighboring CEs enables clustering of compute resources; sharing of array elements such as cache elements, multiplier elements, ALU elements, or control elements; communication between or among neighboring CEs; and the like.

The flow 100 includes providing control 120 for the compute elements on a cycle-by-cycle basis. The controlling the array can include configuration of elements such as compute elements within the array; loading and storing data; routing data to, from, and among compute elements; and so on. A cycle can include a clock cycle, an architectural cycle, a system cycle, a self-timed cycle, and the like. In the flow 100, the control is enabled by a stream of control words 122 generated and provided by the compiler 124. The control words can include microcode control words, compressed control words, encoded control words, and the like. The “wideness” or width of the control words allows a plurality of compute elements within the array of compute elements to be controlled by a single wide control word. For example, an entire row of compute elements can be controlled by that wide control word. In embodiments, the stream of wide control words can include variable length control words generated by the compiler. The control words can be decompressed, used, etc., to configure the compute elements and other elements within the array; to enable or disable individual compute elements, rows and/or columns of compute elements; to load and store data; to route data to, from, and among compute elements; and so on. In other embodiments, the stream of wide control words generated by the compiler can provide direct, fine-grained control of the array of compute elements. The fine-grained control of the compute elements can include enabling or idling individual compute elements; enabling or idling rows or columns of compute elements; etc.

Data processing that can be performed by the array of compute elements can be accomplished by executing tasks, subtasks, and so on. The tasks and subtasks can be represented by control words, where the control words configure and control compute elements within the array of compute elements. The control words comprise one or more operations, where the operations can include data load and store operations; data manipulation operations such as arithmetic, logical, matrix, and tensor operations; and so on. The control words can be compressed by the compiler, by a compressor, and the like. The plurality of wide control words enables compute element operation. Compute element operations can include arithmetic operations such as addition, subtraction, multiplication, and division; logical operations such as AND, OR, NAND, NOR, XOR, XNOR, and NOT; matrix operations such as dot product and cross product operations; tensor operations such as tensor product, inner tensor product, and outer tensor product; etc. The control words can comprise one or more fields. The fields can include one or more of an operation, a tag, data, and so on. In embodiments, a field of a control word in the plurality of control words can signify a “repeat last operation” control word. The repeat last operation control word can include a number of operations to repeat, a number of times to repeat the operations, etc. The plurality of control words enables compute element memory access. Memory access can include access to local storage such as one or more register files or scratchpad storage, memory coupled to a compute element, storage shared by two or more compute elements, cache memory such as level 1 (L1), level 2 (L2), and level 3 (L3) cache memory, a memory system, etc. The memory access can include loading data, storing data, and the like.

In embodiments, the array of compute elements can be controlled on a cycle-by-cycle basis. The controlling the array can include configuration of elements such as compute elements within the array; loading and storing data; routing data to, from, and among compute elements; and so on. A cycle can include a clock cycle, an architectural cycle, a system cycle, a self-timed cycle, and the like. In embodiments, the stream of control words can include compressed control words, variable length control words, etc. The control words can further include wide compressed control words. The control words can be provided as a stream of control words to the array. The control words can include microcode control words, compressed control words, encoded control words, and the like. The width of the control words allows a plurality of compute elements within the array of compute elements to be controlled by a single wide control word. For example, an entire row of compute elements can be controlled by that wide control word. The control words can be decompressed, used, etc., to configure the compute elements and other elements within the array; to enable or disable individual compute elements, rows and/or columns of compute elements; to load and store data; to route data to, from, and among compute elements; and so on.

Various types of compilers can be used to generate the stream of wide control words. The compiler which generates the wide control words can include a general-purpose compiler such as a C, C++, Java, or Python compiler; a hardware description language compiler such as a VHDL or Verilog compiler; a compiler written for the array of compute elements; and the like. In embodiments, the control words comprise compressed control words, variable length control words, and the like. In embodiments, the stream of control words generated by the compiler can provide direct fine-grained control of the 2D array of compute elements. The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. The neural network implementation can include a plurality of layers, where the layers can include one or more of input layers, hidden layers, output layers, and the like. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data and no detailed information from the control word. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

The stream of wide control words that is generated by the compiler can include a conditionality such as a branch. The branch can include a conditional branch, an unconditional branch, etc. Compressed control words can be decompressed by a decompressor logic block that decompresses words from a compressed control word cache on their way to the array. In embodiments, a set of operations associated with one or more compressed control words can include a spatial allocation of subtasks on one or more compute elements within the array of compute elements. In other embodiments, the set of operations can enable multiple, simultaneous programming loop instances circulating within the array of compute elements. The multiple programming loop instances can include multiple instances of the same programming loop, multiple programming loops, etc.

The flow 100 includes initializing 130 a plurality of compute elements within the array of compute elements with a switch statement. The initializing can include configuring the compute elements; configuring elements associated with the compute elements such as controllers, multiplier units, and ALUs; scheduling the compute elements for processing; allocating storage; prioritizing memory access; preloading data; and the like. In the flow 100, the switch statement is mapped 132 into a primitive operation in each element of the plurality of compute elements, and the initializing is based on a control word from the stream of control words. A primitive operation can include an arithmetic operation such as addition or subtraction; a logical operation such as AND, OR, NAND, or NOR; a memory access operation such as load or store; etc. In embodiments, the mapping in each element of the plurality of compute elements can include a spatially adjacent mapping. The spatially adjacent mapping can include mapping operations such as primitive operations to pairs and quads of compute elements, regions and quadrants of compute elements within the array, etc. The spatially adjacent mapping can localize memory accesses for loading and storing data, localize communication among compute elements, and so on.

In embodiments, the spatially adjacent mapping comprises an M×N subarray of the array of compute elements. The M×N subarray can be configured such that M<N, M=N, M>N, and the like. In embodiments, the M×N subarray includes non-primitive mapped compute elements. While primitive operations associated with the switch statement can be mapped to some or all of the compute elements within the M×N subarray, unmapped compute elements within the M×N subarray can be scheduled for execution of tasks, subtasks, and so on. The tasks and subtasks can support the switch statement, can be independent of the switch statement, etc. In embodiments, the spatially adjacent mapping can be determined at compile time by the compiler. The compiler can allocate compute element array resources; can generate command words to initialize compute elements with a switch statement, tasks, and subtasks; and so on.

The flow 100 includes executing 140 each of the primitive operations in an architectural cycle. Discussed throughout, a switch statement comprises a variable such as a decision variable, or an expression, and a plurality of cases. In embodiments, the decision variable can be loaded into the plurality of compute elements from a data cache. The loading into the compute elements can be part of the initializing the compute elements. In embodiments, the decision variable can be provided to the compute elements by the control word. The decision variable can be provided on a cycle-by-cycle basis. A case is executed based on a value associated with the decision variable. A further default “case” can be included to handle a situation where the value of the decision variable does not match any of the cases. A case can be based on an if-else if-else construct. Using a switch statement is more compact and efficient than expressing the switch, cases, and default by combinations of if-else if-else constructions. In embodiments, the cases can be executed in parallel while the switch expression is being evaluated. The parallel execution of the cases can be analogous to preprocessing multiple paths of a multi-way branch prior to evaluating the branch expression. Similarly, the “taken” case can be chosen, while the “untaken” cases can be ignored.

The flow 100 further includes delaying the returning 150 of a result, based on at least one of the primitive operations requiring more than one architectural cycle. While some of the primitive operations that are mapped to compute elements can be executed in an architectural cycle, there are other primitive operations that can require more than one architectural cycle. In a usage example, a primitive operation might require that data be obtained from memory. Since memory access latency can be variable, the loading from or storing to memory can require more than one architectural cycle to complete. In embodiments, the delaying can be based on the decision variable. The decision variable can be used to select a case. The selected case can require more than one architectural cycle to complete. In other embodiments, the delaying can avoid a memory access hazard such as a hazardous load or store. Memory access hazards can include write-after-read, read-after-write, write-after-write conflicts, etc. In other embodiments, the decision variable can be propagated within the architectural cycle. The decision variable that is propagated can be used to determine which case statement matches the decision variable, whether the default is used, etc. In other embodiments, the delay can be associated with a priority, precedence, etc.

The flow 100 includes returning a result 160 for the switch statement. The result can be returned as a value, a reference, a pointer, an offset, and so on. In embodiments, the result can be provided by one of the plurality of compute elements. The compute elements can determine the result based on a primitive operation associated with the compute element, input data provided to the operation, and the like. In the flow 100, the returning is determined 162 by a decision variable. The decision variable can be used to identify, select, or otherwise choose the result to be returned. Recall that the cases, the default, and so on associated with the switch block statement can be executed substantially in parallel within an architectural cycle. The “correct” case, that is, the case that matches a value of the decision variable, can be returned. The flow 100 further includes updating 164 the decision variable. The updated decision variable can be used subsequently by the same switch statement, by another switch statement, etc. In embodiments, the updating the decision variable can be based on a load into the array of compute elements from a data cache. The data cache contents that are loaded into the array can be used as the value of the decision variable, can be used in an expression such as an integer expression associated with the switch, and so on. In other embodiments, the updating the decision variable can be based on an outcome of one of the primitive operations. The outcome of one of the primitive operations can include a result of an arithmetic, logical, or data access operation, etc. In other embodiments, the outcome of one of the primitive operations can include a variable compare operation. The variable compare operation can include comparing a variable to a second variable, a variable to a constant, and the like. The variable compare operation can be part of an expression associated with the switch command. In other embodiments, the variable compare operation can satisfy a case statement derived from the switch statement. Recall that the value of the decision value or the outcome of an expression associated with the switch command can be compared to each of the cases associated with the switch to find a match. If a match to a case is found, the matching case can be used to generate a result. If a match to a case is not found, then the default (if present) can be used to generate the result. In further embodiments, the updating the decision variable can be accomplished by broadcasting the decision variable. Discussed below and throughout, the updating the decision variable can be accomplished by broadcasting the decision using a bus. In embodiments, the bus comprises a series of point-to-point wires that enable fast communication between each element of the compute element array and a control unit.

Further embodiments include decompressing a stream of compressed control words. The decompressed control words can comprise one or more operations, where the operations can be executed by one or more compute elements within the array of compute elements. The decompressing the compressed control words can be accomplished using a decompressor element. The decompressor element can be coupled to the array of compute elements. In embodiments, the decompressing by a decompressor operates on compressed control words that can be ordered before they are presented to the array of compute elements. The presented compressed control words that were decompressed can be executed by one or more compute elements. Further embodiments include executing operations within the array of compute elements using the plurality of compressed control words that were decompressed. The executing operations can include configuring compute elements, loading data, processing data, storing data, generating control signals, and so on. The executing the operations within the array can be accomplished using a variety of processing techniques such as sequential execution techniques, parallel processing techniques, etc.

The control words that are generated by the compiler can include a conditionality. In embodiments, the control words include branch decision operations, which can then get “taken” by the control unit. Code, which can include code associated with an application such as image processing, audio processing, and so on, can include conditions which can cause execution of a sequence of code to transfer to a different sequence of code. The conditionality can be based on evaluating an expression such as a Boolean or arithmetic expression. In embodiments, the conditionality can determine code jumps. The code jumps can include conditional jumps as just described, or unconditional jumps such as a jump to halt, exit, or terminate an instruction. The conditionality can be determined within the array of elements. In embodiments, the conditionality can be established by a control unit. In order to establish conditionality by the control unit, the control unit can operate on a control word provided to the control unit. Further embodiments include suppressing memory access stores for untaken branch paths. In parallel processing techniques, each path or side of a conditionality such as a branch can begin execution prior to the evaluating the conditionality that will decide which path to take. Once the conditionality has been decided, execution of operations associated with the taken path or side can continue. Operations associated with the untaken path can be suspended. Thus, any memory access stores associated with the untaken path can be suppressed because they are no longer relevant. In embodiments, the control unit can operate on decompressed control words. The control words can be decompressed by a decompressor logic block that decompresses words from a compressed control word cache on their way to the array. In embodiments, the set of directions can include a spatial allocation of subtasks on one or more compute elements within the array of compute elements.

The operations that are executed by the compute elements within the array can include arithmetic operations, logical operations, matrix operations, tensor operations, and so on. The operations that are executed are contained in the control words. Discussed above, the control words can include a stream of wide control words generated by the compiler. The control words can be used to control the array of compute elements on a cycle-by-cycle basis. A cycle can include a local clock cycle, a self-timed cycle, a system cycle, and the like. In embodiments, the executing occurs on an architectural cycle basis. An architectural cycle can include a read-modify-write cycle. In embodiments, the architectural cycle basis reflects non-wall clock, compiler time. The execution can include distributed execution of operations. In embodiments, the distributed execution of operations can occur in two or more compute elements within the array of compute elements, within a grouping of compute elements, and so on. The compute elements can include independent or individual compute elements, clustered compute elements, etc. Execution of specific compute element operations can enable parallel operation processing. The parallel operation processing can include processing nodes of a graph that are independent of each other, processing independent tasks and subtasks, etc. The operations can include arithmetic, logic, array, matrix, tensor, and other operations. A given compute element can be enabled for operation execution, idled for a number of cycles when the compute element is not needed, etc. The operations that are executed can be repeated. An operation can span multiple wall clock cycles before it is complete, which is the case in a multicycle operation such as a square root operation.

The operation that is being executed can include data dependent operations. In embodiments, the plurality of control words includes two or more data dependent branch operations. The branch operation can include two or more branches, where a branch is selected based on an operation such as an arithmetic or logical operation. In a usage example, a branch operation can determine the outcome of an expression such as A>B. If A is greater than B, then one branch can be taken. If A is less than or equal to B, then another branch can be taken. In order to expedite execution of a branch operation, sides of the branch can be precomputed prior to datum A and datum B being available. When the data is available, the expression can be computed, and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the generating, the customizing, and the executing can enable background memory access. The background memory access can enable a control element to access memory independently of other compute elements, a controller, etc. In embodiments, the background memory access can reduce load latency. Load latency is reduced since a compute element can access memory before the compute element exhausts the data that the compute element is processing.

The array of compute elements can accomplish autonomous operation. The autonomous operation can be based on a buffer such as an autonomous operation buffer (either local to a single CE or local to a single CE and used by a cooperating group of nearby CEs) that can be loaded with an instruction that can be executed using a “fire and forget” technique, where instructions are loaded in the autonomous operation buffer and the instructions can be executed without further supervision by a control word. The autonomous operation of the compute element can be based on operational looping, where the operational looping is enabled without additional control word loading. The looping can be enabled based on ordering memory access operations such that memory access hazards are avoided. Note that latency associated with access by a compute element to storage can be significant and can cause operation of the compute element to stall. A compute element operation counter can be coupled to the autonomous operation buffer. The compute element operation counter can be used to control a number of times that the instructions within the autonomous operation buffer are cycled through. The compute element operation counter can be used to indicate or “point to” the next instruction to be provided to a compute element, a multiplier element, and ALU, or another element within the array of compute elements. In embodiments, the autonomous operation buffer and the compute element operation counter enable compute element operation execution. The compute element operation execution can include executing one or more instructions, looping executions, and the like. In embodiments, the compute element operation execution involves operations not explicitly specified in a control word. Operations not explicitly specified in a control word can include low level operations within the array of compute elements, such as data transfer protocols, execution completion and other signal generation techniques, etc.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

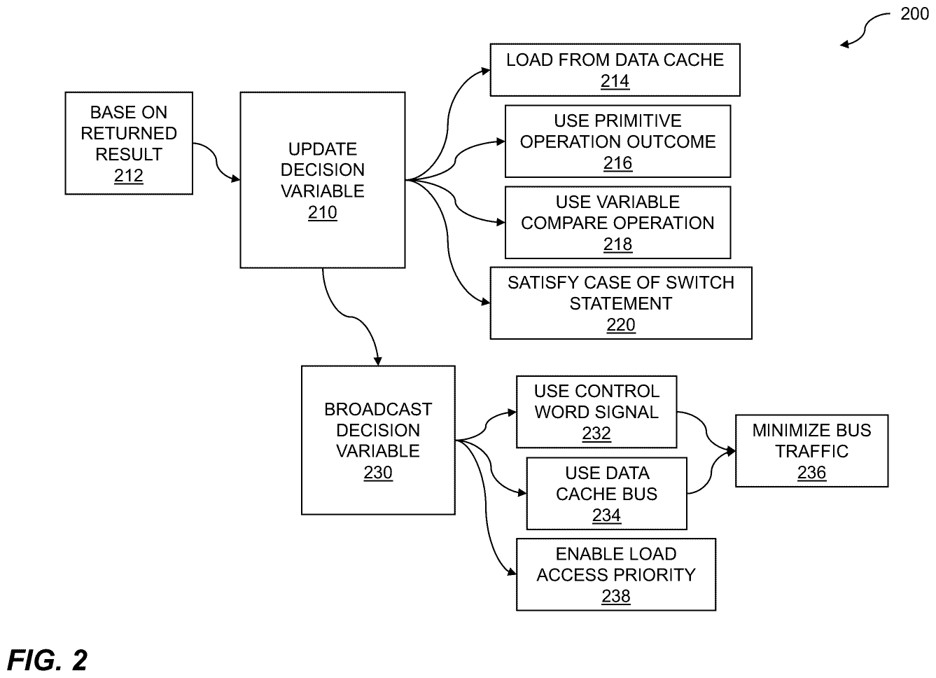

FIG. 2 is a flow diagram for decision variable handling. A switch statement can include a decision variable and cases. The cases can be based on an if, else if, else construct. The switch statement can further include a default “case”, where the default can be executed when the evaluation of the decision variable does not match any of the cases. The decision variable can be evaluated to determine which of the cases is selected for returning a result for the switch statement. The decision variable can be updated, where the updating the decision variable can be based on an outcome of one of the primitive compute element operations mapped from the switch statement. The updating the decision variable can be accomplished by broadcasting the decision variable to compute elements within an array of compute elements. The decision variable handling, which can include decision variable evaluation, use, update, etc., enables parallel processing with switch block execution. An array of compute elements is initialized, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. A plurality of compute elements within the array of compute elements is initialized with a switch statement, wherein the switch statement is mapped into a primitive operation in each element of the plurality of compute elements, and wherein the initializing is based on a control word from the stream of control words. Each of the primitive operations is executed in an architectural cycle. A result is returned for the switch statement, wherein the returning is determined by a decision variable.

The flow 200 includes updating 210 the decision variable. Discussed previously, a switch statement comprises cases and an optional default. The switch is more efficient than long strings of if-then-else constructs because the individual cases are associated with specific parallel evaluations of the decision variable. The cases can be executed in parallel, and the result of the selected case can be provided as the true result. The result can be used to determine the next “symbol” or data to be used. The result can be used to update the decision variable for a next switch block statement. In the flow 200, the updating the decision variable is based on a load 214 into the array of compute elements from a data cache. The loaded data can be provided to compute elements within the spatially adjacent subarray of the array of compute elements. In embodiments, the result that was returned comprises successful completion of the executing. Successful completion can be based on completed execution of the case selected, which is determined by the decision variable. In the flow 200, the updating the decision variable is based on the result 212 that was returned. Recall that the result that is returned can be determined, or gated, by the previous decision variable. The previous decision variable selects or gates the case result or the default result and returns the gated result. The returned result can be used as the updated decision variable, can be used to evaluate the updated decision variable, and so on.

In the flow 200, the updating the decision variable is based on an outcome 216 of one of the primitive operations. The primitive operations can include arithmetic operations, logical operations, and so on. The outcome of one of the primitive operations can be determined within a cycle such as an architectural cycle. In the flow 200, the outcome of one of the primitive operations comprises a variable compare 218 operation. The variable compare operation can compare the variable to a constant, to another variable, etc. The variable compare operation can include an equality, an inequality, and the like. In embodiments, the variable compare operation can satisfy a case statement 220 derived from the switch statement. In a usage example, the switch statement can switch on a variable N. The cases can execute operations based on comparing the variable N to the expression associated with a particular case. In the example, cases can be defined such as a first case for N=1, a second case for N=2, a third case for N=7, and so on. A default case can also be defined so that if none of the cases is selected, then a default operation can be performed. So, when N=1, the case 1 is executed; when N=2, case 2 is executed, etc.

In the flow 200, the updating the decision variable is accomplished by broadcasting 230 the decision variable. The decision variable can be broadcast to one or more compute elements within the array of compute elements. The compute elements to which the decision variable is broadcast can include the compute elements within the M×N subarray within the array of compute elements. The broadcasting can be accomplished using one or more communication channels, datapaths, buses, and so on. In the flow 200, the broadcasting occurs along a (horizontal) signal wire that carries control word traffic 232 between each bit of the decompressed control word and the compute element array. The control word traffic can include control words provided on a cycle-by-cycle basis. In embodiments, the broadcasting can occur along a horizontal bus. In embodiments, the broadcasting occurs along a bus that carries data cache traffic 234. The broadcast can occur during data transfers between the data cache and control elements within the array. Minimizing traffic on a bus can lessen data access times by reducing bus contention, memory contention, and so on. The minimizing traffic can be accomplished as part of mapping a switch statement to compute elements. In the flow 200, the mapping in each element of the plurality of compute elements is performed by the compiler to minimize broadcasting 236 along the bus that carries data cache traffic. That is, use of the bus that transfers control word traffic is preferred to the bus that transfers data cache traffic. The flow 200 further includes delaying the returning a result, based on at least one of the primitive operations requiring more than one architectural cycle. The delaying the refresh of the result enables load access priority 238 of data input to the compute elements, allows results of primitive operations to be stored to memory, and so on. In embodiments, the delaying can be based on the decision variable. The delaying can be used to prevent memory hazard conditions such as write-after-read, read-after-write, and write-after-write conflicts, etc. In other embodiments, the decision variable can be propagated within the architectural cycle. The architectural cycle can include the same cycle in which operations such as primitive operations are executed. A primary bus for decision variables, or state variables, can enable broadcasting along a horizontal data bus, which can comprise one wire in each direction along each row of the array. This bus can also be used to deliver large immediate data into the CE array from the control word.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

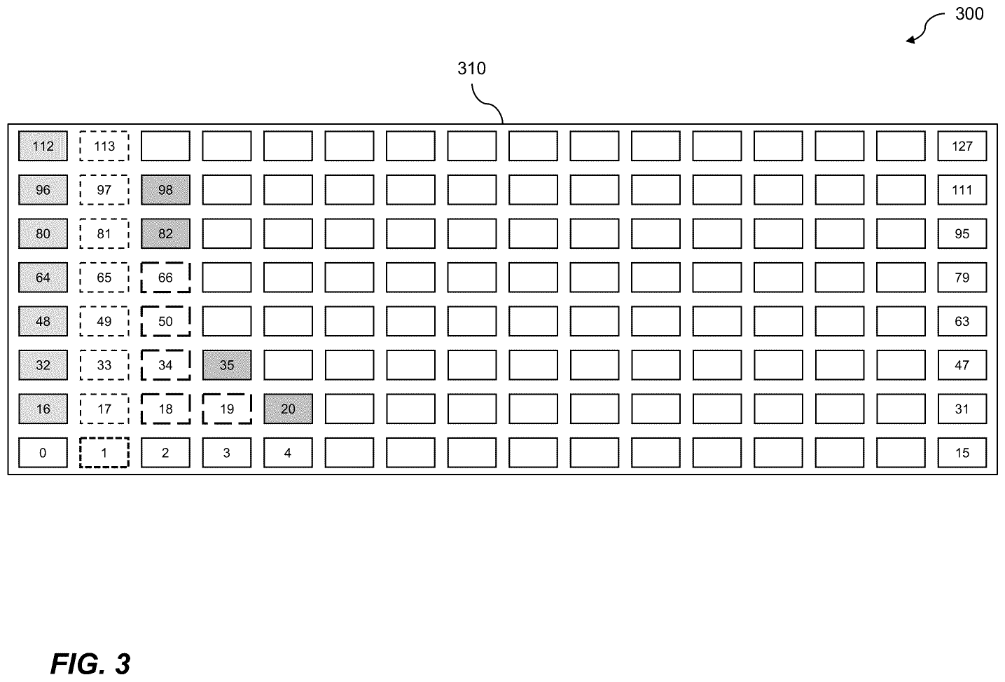

FIG. 3 is an infographic showing spatial mapping of switch block function. A switch block can comprise an expression and a plurality of “cases”. The cases can perform operations such as primitive operations based on evaluating the expression. Each case can comprise if, else if, else statements. Since determination of which one of the plurality of case statements will be selected cannot be known a priori, then each case can be loaded into compute elements with a compute element array. The compute elements into which the cases can be loaded can be spatially adjacent. Further, the switch block can be mapped into a primitive operation in each element of the plurality of compute elements. A primitive operation, which can include arithmetic, logical, and data transfer operations, etc., can be executed in an architectural cycle. The spatial mapping enables parallel processing with switch block execution. An array of compute elements is accessed, wherein each compute element within the array of compute elements is known to a compiler and is coupled to its neighboring compute elements within the array of compute elements. Control is provided for the compute elements on a cycle-by-cycle basis, wherein control is enabled by a stream of wide control words generated by the compiler. A plurality of compute elements is initialized within the array of compute elements with a switch statement, wherein the switch statement is mapped into a primitive operation in each element of the plurality of compute elements, and wherein the initializing is based on a control bunch from a control word within the stream of control words. Each of the primitive operations is executed in an architectural cycle. A result is returned for the switch statement, wherein the returning is determined by a decision variable.

Spatial mapping of a switch block function is shown 300. A switch block can comprise an evaluation of an expression associated with a decision variable and a plurality of cases. The switch block can further include a default “case” which handles expression evaluations that do not match any of the cases. While the cases described herein can include “if”, “else if”, and “else” blocks, the cases can further include function calls, routine and subroutine calls, etc. Described herein, note that “if/if else/else” operation statements occasionally appear in quotation marks for added clarity, the quotation marks are not generally required to enable clear and unambiguous meaning to one skilled in the art. A switch statement can be mapped into a primitive operation in each element of the plurality of compute elements. The decision variable can be globally held by all compute elements initialized to execute a switch statement. Described throughout, the decision variable can be updated. The updating the decision variable can be accomplished using a broadcast technique. The updating can include updating the decision variable to memory.

The cases associated with the switch block can be mapped into a subarray within the array of compute elements. In embodiments, the mapping in each element of the plurality of compute elements can include a spatially adjacent mapping. The spatially adjacent mapping can include pairs or quads of compute elements, portions of the array, quadrants of the array, and so on. In embodiments, the spatially adjacent mapping can include an M×N subarray of the array of compute elements. While some subarray elements can be mapped with primitive operations associated with the switch statement, other compute elements can include non-primitive mapped compute elements. The mapping can be initialized to improve communication of control words and data cache information among the compute elements of the M×N subarray. In embodiments, the spatially adjacent mapping is determined at compile time by the compiler.

An M×N, or 8×16 subarray of compute elements is shown 310. The switch statement is mapped into the subarray such that each “if, else if, else” associated with a case can be executed substantially in parallel. The “winner” case is the case selected or determined by the decision variable. As a result of executing the cases substantially in parallel, latency associated with case calculations are constant irrespective of which case is chosen by the decision variable. The case evaluations are loaded into compute elements 16, 32, 48, 64, 80, 96, and 112. To the right of the compute elements 16, 32, 48, 64, 80, 96, and 112 are the compute elements initialized for each “if”, each “else if”, and each “else” block, if present, for each case. In the figure, blocks 17, 33, 49, 65, 81, 97, and 113 correspond to “if” evaluation blocks; blocks 18, 19, 34, 50, and 66 correspond to “else if” evaluation blocks; and blocks 20, 35, 82, and 98 correspond to “else” evaluation blocks. Notice that the case associated with block 16 has an if, two else ifs, and an else block, while block 112 has only an if evaluation block. The cases, of which there are seven in this example, execute in parallel in an architectural cycle. The address generation block, block 1, generates addresses for load data and store data. In embodiments, the M×N subarray includes non-primitive mapped compute elements. The non-primitive compute elements can include compute elements within the subarray that were not initialized with the switch statement. These non-primitive compute elements can be initialized, configured, scheduled, and so on for compute element operations associated with tasks, subtasks, etc., and not associated with the switch statement.

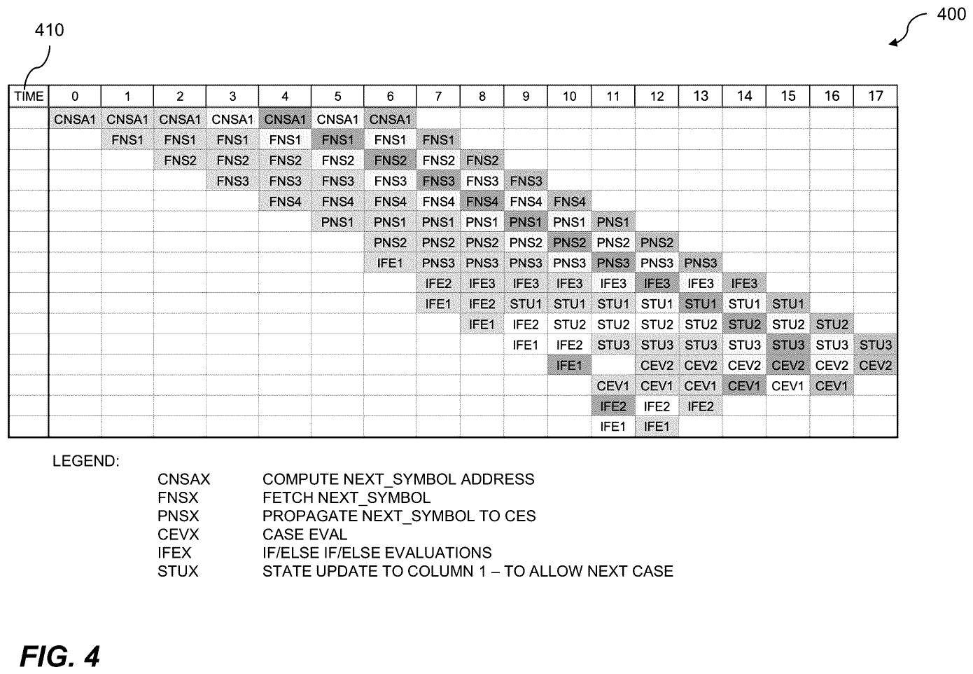

FIG. 4 is an infographic that illustrates spatial and temporal mapping. Discussed previously and throughout, compute elements can be configured to implement a switch statement, where the initial configuration is based on a control word. The switch statement is mapped into a primitive operation in each element. In order to improve operation efficiency, the mapping in each element of the plurality of compute elements can include a spatially adjacent mapping, where the spatially adjacent mapping can include an M×N subarray of the array of compute elements. The spatially adjacent mapping is determined by the compiler at compile time. The timing or temporal mapping of the switch statement further enhances execution of the switch statement. The spatial and temporal mapping enable parallel processing with switch block execution. An array of compute elements is accessed. Each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. A plurality of compute elements within the array of compute elements is initialized with a switch statement. The switch statement is mapped into primitive operations in each element of the plurality of compute elements, and the initializing is based on a control word from the stream of control words. Each of the primitive operations is executed in an architectural cycle. A result is returned for the switch statement, wherein the returning is based on which case is determined by the decision variable.

A resource utilization pipeline based on spatial and temporal mapping is shown 400. A single evaluation of a core state transition can be represented as the core state transition can flow through stages of evaluation. The stages of evaluation can include: computing an address for a next symbol; fetching the next symbol; propagating the next symbol to compute elements initialized with a switch statement; evaluating cases associated with the switch statement; executing if, else if, and else evaluations; and updating a decision variable. The next symbol can include a data item, where the data item can be loaded from memory. The data item can include a value such as an integer, real, or floating-point value. The data item can be loaded or fetched from memory. The memory can include storage which is local to the compute element such as a register file, a cache memory, a system memory, and so on. The next symbol can be propagated to compute elements initialized to execute the switch statement. The propagating can be accomplished using buses accessible to the compute elements. The choice of bus that is used can be based on minimizing traffic on a bus. In embodiments, broadcasting along the bus that carries data cache traffic can be minimized by the compiler.

The cases can be evaluated on the compute elements, where the compute elements can execute the cases in parallel. The cases can be based on mapping the switch statement into primitive operations that can be executed in the compute elements. In embodiments, each of the primitive operations can be executed in an architectural cycle. The switch statement can include cases that are based on if, else if, and else operations. The if, else if, and else operations can be evaluated. The case result can be chosen based on a decision variable. In embodiments, a result can be indicated for the switch statement, where the returning a result is determined by the decision variable. The decision variable can be updated. In embodiments, the updating the decision variable can be based on a load into the array of compute elements from a data cache. The data cache can include a multilevel cache that can be accessible to compute elements within the array of compute elements. Various techniques can be used for the updating. In embodiments, the updating the decision variable can be accomplished by broadcasting the decision variable. In embodiments, the mapping in each element of the plurality of compute elements can be performed by the compiler to minimize broadcasting along the bus that carries data cache traffic.

Returning to the figure, a single evaluation of a core decision transition is shown as the transition flows through the stages of evaluation. The stages can comprise an evaluation pipeline. The next symbol address (CNSAx) is calculated for a next symbol. The next symbol is fetched (FNSx) from memory for symbols 1 through 4. The full latency for a single evaluation can be twelve cycles 410, where the full latency can include a memory load of the next symbol. A cycle can include an architectural cycle. Note that since the computations can be performed on spatially adjacent and mapped compute elements, and since the primitive operations can be executed in an architectural cycle, then the evaluations can be fully pipelined. As a result, one full core decision transition evaluation can be performed every cycle when the pipeline is full.

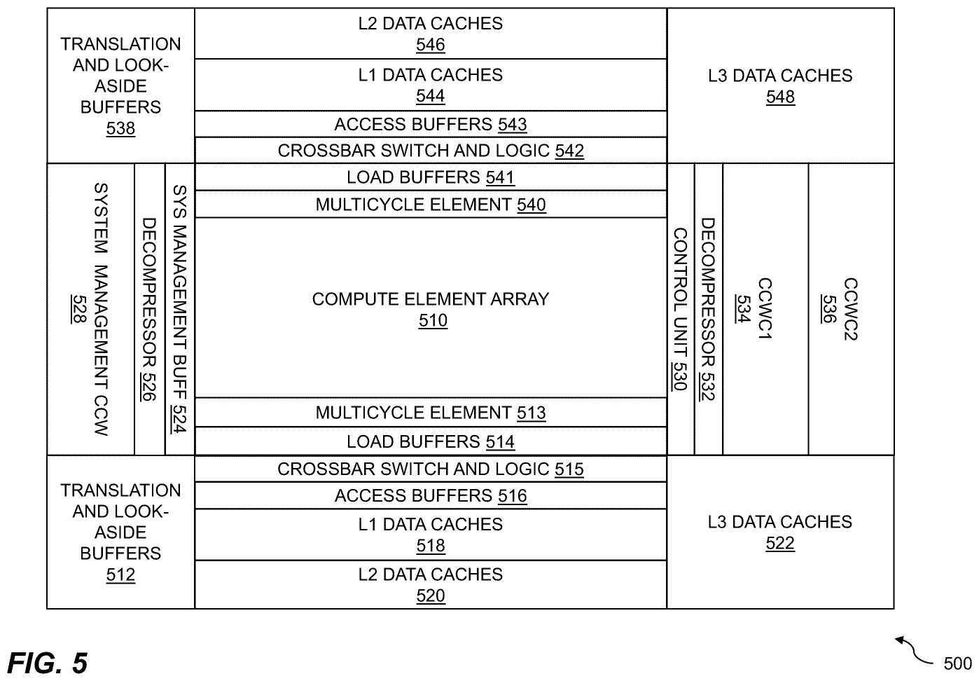

FIG. 5 is a system block diagram for a highly parallel architecture with a shallow pipeline. The highly parallel architecture can comprise a variety of components such as compute elements, processing elements, buffers, one or more levels of cache storage, system management, arithmetic logic units, multipliers, memory management units, and so on. The various components can be used to accomplish parallel processing of tasks, subtasks, and the like. The parallel processing is associated with program execution, job processing, etc. The parallel processing is enabled based on parallel processing using switch block execution. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. A plurality of compute elements within the array of compute elements is initialized with a switch statement, wherein the switch statement is mapped into a primitive operation in each element of the plurality of compute elements, and wherein the initializing is based on a control word from the stream of control words. Each of the primitive operations is executed in an architectural cycle. A result for the switch statement is returned, wherein the returning is determined by a decision variable.

A system block diagram 500 for a highly parallel architecture with a shallow pipeline is shown. The system block diagram can include a compute element array 510. The compute element array 510 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 500 can include translation and look-aside buffers such as translation and look-aside buffers 512 and 538. The translation and look-aside buffers can comprise memory caches, where the memory caches can be used to reduce storage access times.

The system block diagram 500 can include logic for load and store access order and selection. The logic for load and store access order and selection can include crossbar switch and logic 515 along with crossbar switch and logic 542. Crossbar switch and logic 515 can accomplish load and store access order and selection for the lower data cache blocks (518 and 520), and crossbar switch and logic 542 can accomplish load and store access order and selection for the upper data cache blocks (544 and 546). Crossbar switch and logic 515 enables high-speed data communication between the lower-half compute elements of compute element array 510 and data caches 518 and 520 using access buffers 516. Crossbar switch and logic 542 enables high-speed data communication between the upper-half compute elements of compute element array 510 and data caches 544 and 546 using access buffers 543. The access buffers 516 and 543 allow logic 515 and logic 542, respectively, to hold, load, or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 518 and 520 and upper data caches 544 and 546.

The system block diagram 500 can include lower load buffers 514 and upper load buffers 541. The load buffers can provide temporary storage for memory load data so that it is ready for low latency access by the compute element array 510. The system block diagram can include dual level 1 (L1) data caches, such as L1 data caches 518 and 544. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 520 and 546. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 522 and 548. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 500 can include lower multicycle element 513 and upper multicycle element 540. The multicycle elements (MEMs) can provide efficient functionality for operations, such as multiplication operations, that span multiple cycles. The MEMs can provide further functionality for operations that can be of indeterminant cycle length, such as some division operations, square root operations, and the like. The MEMs can operate on data coming out of the compute element array and/or data moving into the compute element array. Multicycle element 513 can be coupled to the compute element array 510 and load buffers 514, and multicycle element 540 can be coupled to compute element array 510 and load buffers 541.

The system block diagram 500 can include a system management buffer 524. The system management buffer can be used to store system management codes or control words that can be used to control the array 510 of compute elements. The system management buffer can be employed for holding opcodes, codes, routines, functions, etc. which can be used for exception or error handling, management of the parallel architecture for processing tasks, and so on. The system management buffer can be coupled to a decompressor 526. The decompressor can be used to decompress system management compressed control words (CCWs) from system management compressed control word buffer 528 and can store the decompressed system management control words in the system management buffer 524. The compressed system management control words can require less storage than the decompressed control words. The system management CCW component 528 can also include a spill buffer. The spill buffer can comprise a large static random-access memory (SRAM), which can be used to provide rapid support of multiple nested levels of exceptions.

The compute elements within the array of compute elements can be controlled by a control unit such as control unit 530. While the compiler, through the control word, controls the individual elements, the control unit can pause the array to ensure that new control words are not driven into the array. The control unit can receive a decompressed control word from a decompressor 532 and can drive out the decompressed control word into the appropriate compute elements of compute element array 510. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 534. CCWC1 can include a cache such as an L1 cache that includes one or more compressed control words. CCWC1 can be coupled to a further compressed control word store such as compressed control word cache 2 (CCWC2) 536. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 532 can be coupled between CCWC1 534 (now DCWC1) and CCWC2 536.

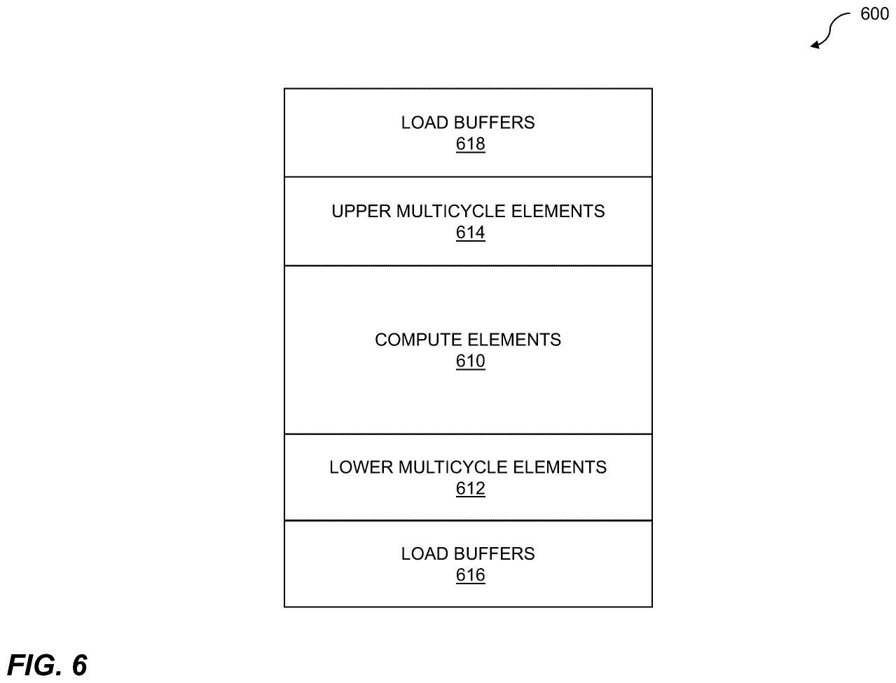

FIG. 6 illustrates compute element array detail 600. A compute element array can be coupled to components which enable the compute elements within the array of compute elements to process one or more tasks, subtasks, switch blocks, and so on. The components can access and provide data, perform specific high-speed operations, and the like. The components can be configured into a variety of computational topologies. The compute element array and its associated components enable parallel processing with switch block execution. The compute element array 610 can perform a variety of processing tasks, where the processing tasks can include operations such as arithmetic, vector, matrix, or tensor operations; audio and video processing operations; neural network operations; etc. The compute elements can be coupled to multicycle elements such as lower multicycle elements 612 and upper multicycle elements 614. The multicycle elements can provide functionality to perform, for example, high-speed multiplications associated with general processing tasks, multiplications associated with neural networks such as deep learning networks, multiplications associated with vector operations, and so on. The multiplication operations can span multiple cycles. The MEMS can provide further functionality for operations that can be of indeterminant cycle length, such as some division operations, square root operations, and the like.

The compute elements can be coupled to load buffers such as load buffers 616 and load buffers 618. The load buffers can be coupled to the L1 data caches as discussed previously. In embodiments, a crossbar switch (not shown) can be coupled between the load buffers and the data caches. The load buffers can be used to load storage access requests from the compute elements. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data memory and control word memory) can be performed. The memory systems can be free running and can continue to operate while the array is paused. Because multicycle latency can occur due to control signal transport that results in additional “dead time”, allowing the memory system to “reach into” the array and to deliver load data to appropriate scratchpad memories while the array is paused can be beneficial. This mechanism can operate such that the array state is known, as far as the compiler is concerned. When array operation resumes after a pause, new load data will have arrived at a scratchpad, as required for the compiler to maintain the statically scheduled model.

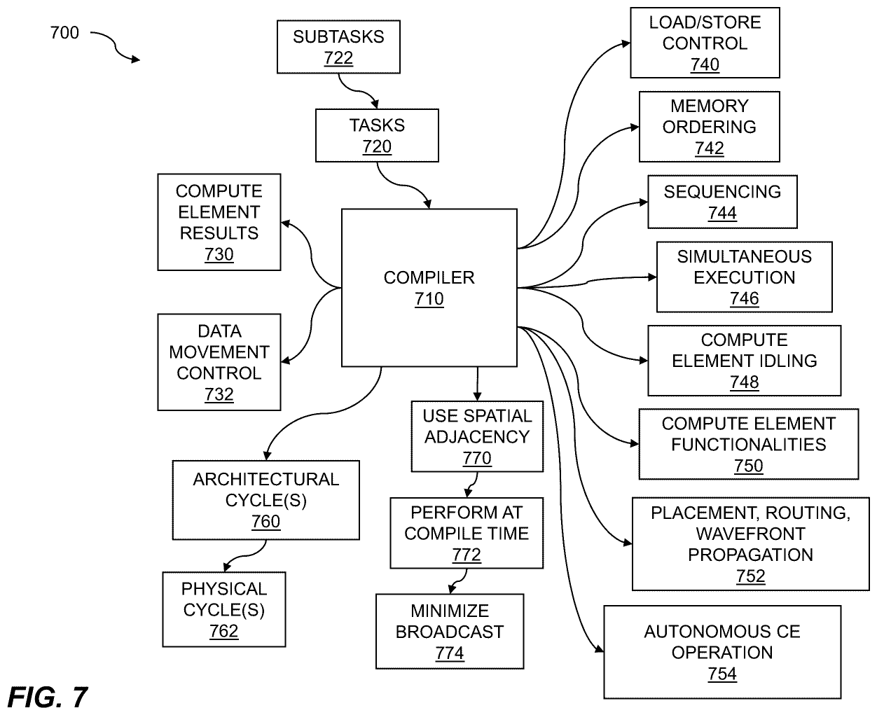

FIG. 7 is a system block diagram for compiler interactions. Discussed throughout, compute elements within an array are known to a compiler which can compile processes, tasks, subtasks, and so on for execution on the array. The compiled tasks, subtasks, etc. comprise operations which can be executed on one or more compute elements within the array. The compiled tasks and subtasks are executed to accomplish task processing. The task processing can be accomplished based on parallel processing of the tasks and subtasks. Processing the tasks and subtasks includes accessing memory such data memory, a cache, a scratchpad memory, etc. The memory accesses can cause memory access hazards if the memory accesses are not carefully orchestrated. A variety of interactions, such as placement of tasks, routing of data, and so on, can be associated with the compiler. The compiler interactions enable parallel processing with switch block execution. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. A plurality of compute elements is initialized within the array of compute elements with a switch statement, wherein the switch statement is mapped into a primitive operation in each element of the plurality of compute elements, and wherein the initializing is based on a control word from the stream of control words. Each of the primitive operations is executed in an architectural cycle. A result is returned for the switch statement, wherein the returning is determined by a decision variable.

The system block diagram 700 includes a compiler 710. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as a low-level virtual machine (LLVM) intermediate representation (IR). The compiler can generate a set of directions that can be provided to the compute elements and other elements within the array. The compiler can be used to compile tasks 720. The tasks can include a plurality of tasks associated with a processing task. The tasks can further include a plurality of subtasks 722. The tasks can be based on an application such as a video processing or audio processing application. In embodiments, the tasks can be associated with machine learning functionality. The compiler can generate directions for handling compute element results 730. The compute element results can include results derived from arithmetic, vector, array, and matrix operations; Boolean operations; and so on. In embodiments, the compute element results are generated in parallel in the array of compute elements. Parallel results can be generated by compute elements, where the compute elements can share input data, use independent data, and the like. The compiler can generate a set of directions that controls data movement 732 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler 710 can provide directions for task and subtask handling, input data handling, intermediate and resultant data handling, and so on. The directions can include one or more operations, where the one or more operations can be executed by one or more compute elements within the array of compute elements. The compiler can further generate directions for configuring the compute elements, storage elements, control units, ALUs, and so on, associated with the array. As previously discussed, the compiler generates directions for data handling to support the task handling. The directions can further enable spatially adjacent mapping of compute elements to support switch block execution. In embodiments, spatially adjacent mapping can be determined at compile time by the compiler. In the system block diagram, the data movement can include loads and stores 740 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, a level 2 (L2) cache, a level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 742. Memory data can be ordered based on task data requirements, subtask data requirements, and so on. The memory data ordering can enable parallel execution of tasks and subtasks.

In the system block diagram 700, the ordering of memory data can enable compute element result sequencing 744. For task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 746 of two or more potential compiled task outcomes based on the set of directions. The code that is compiled by the compiler can include branch points, where the branch points can include computations or flow control. Flow control transfers program execution to a different sequence of control words. Since the result of a branch decision, for example, is not known a priori, the initial operations associated with both paths are encoded in the currently executing control word stream. When the correct result of the branch is determined, the sequence of control words associated with the correct branch result continues execution, while the operations for the branch path not taken are halted and side effects may be flushed. In embodiments, the two or more potential branch paths can be executed on spatially separate compute elements within the array of compute elements.

The system block diagram includes compute element idling 748. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 750. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 752 within the array of compute elements. The compiler can generate directions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can implement and control how execution of tasks and subtasks proceeds through the array of compute elements. The system block diagram 700 can include autonomous compute element (CE) operation 754. As described throughout, autonomous CE operation enables one or more operations to occur outside of direct control word management.

In the system block diagram, the compiler can control architectural cycles 760. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met. That is, the array of compute elements does not have to wait for either dependent data to load or for a full memory buffer to clear. In the system block diagram, the architectural cycle can include one or more physical cycles 762. A physical cycle can refer to one or more cycles at the element level required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. Various operand sizes can be used. In embodiments, the operand size can include bytes, half-words, words, and doublewords.

The system block diagram 700 includes using spatial adjacency 770. Recall that control for the compute elements is provided on a cycle-by-cycle basis. A control word can be used to initialize a plurality of compute elements within the array of compute elements with a switch statement. The switch statement can be mapped into a primitive operation in each element of the plurality of compute elements. A primitive operation can include an arithmetic operation, a logical operation, a data transfer operation, and so on. In embodiments, the mapping in each element of the plurality of compute elements can include a spatially adjacent mapping. The spatially adjacent mapping can include pairs or quads of compute elements, quadrants or regions of compute elements, and so on. In embodiments, the spatially adjacent mapping can include an M×N subarray of the array of compute elements. The M×N array can include a portion of the compute elements array, the entire array, etc. The M×N array can include compute elements onto which primitive operations associated with switch block operations have been mapped, compute elements configured for other operations that can be associated with the switch block operation, etc.

In the system block diagram 700, the spatially adjacent mapping is determined at compile time by the compiler 772. The compute element array scheduling associated with spatially adjacent mapping can be given priority by the compiler over configuration of other compute elements within the array. The spatially adjacent mapping can enable resource sharing among compute elements within the M×N array, sharing with other compute elements of the array of compute elements, and so on. The resource sharing can include shared data, shared storage, shared control words, and the like. The spatially adjacent mapping can provide additional resource sharing and conservation. Recall that the results of a switch statement can be determined by a decision variable. The decision variable can determine which branch or case provided the result of a switch block execution. In embodiments, the updating the decision variable can be based on a load into the array of compute elements from a data cache. The data cache can contain input data, temporary data, resulting data, and so on. The data cache can comprise a multilevel cache. In embodiments, the updating the decision variable can be accomplished by broadcasting the decision variable. In a usage example, compute elements within the array of compute elements can be accessed “vertically” through the array, “horizontally” through the array, or by accessing the compute elements both vertically and horizontally. The directions “vertical” and “horizontal” are arbitrarily but consistently assigned, and are used for illustrative purposes only. As described herein, data cache traffic can be provided vertically through the array of compute elements, while control word traffic can be provided horizontally through the array.

In the block diagram 700, the mapping can be performed to minimize broadcasting 774. In embodiments, the mapping in each element of the plurality of compute elements can be performed by the compiler to minimize broadcasting along the bus that carries data cache traffic. The minimizing broadcasting can enhance data cache traffic from load buffers or the data cache containing data to compute elements within the array of compute elements by reducing the amount of data transferred on the bus that carries data cache traffic. The reduced traffic reduces bus contention issues. In another embodiment, the mapping in each element of the plurality of compute elements can be performed by the compiler to minimize broadcasting along the bus that carries data cache traffic. The minimizing increases data cache transfers, reduces bus contention, etc.

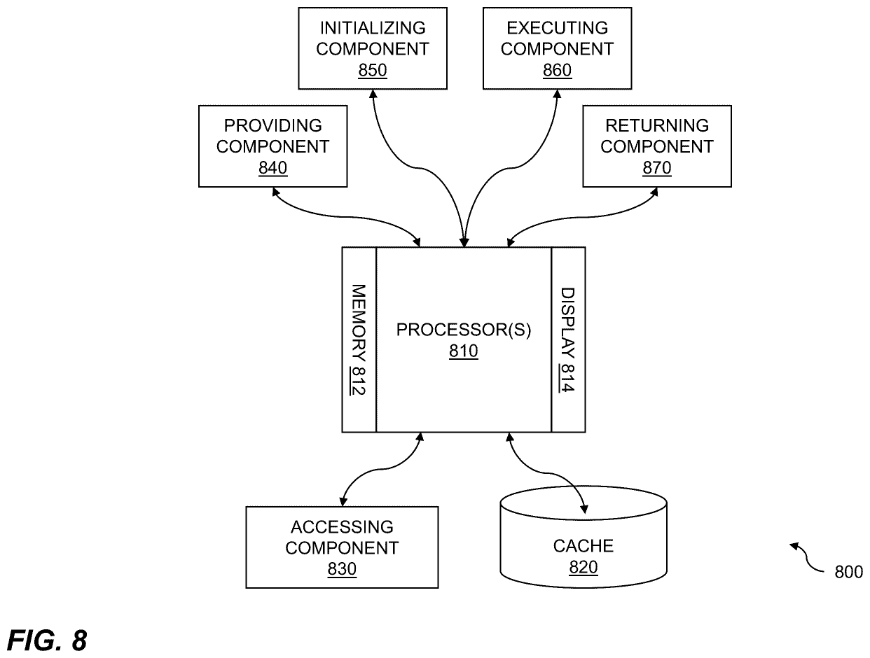

FIG. 8 is a system diagram for parallel processing. The parallel processing is enabled by parallel processing with switch block execution. The system 800 can include one or more processors 810, which are attached to a memory 812 which stores instructions. The system 800 can further include a display 814 coupled to the one or more processors 810 for displaying data such as switch block execution information and switch statement results; intermediate steps; directions; compressed control words; fixed-length control words; control words implementing Very Long Instruction Word (VLIW) functionality; topologies including systolic, vector, cyclic, spatial, streaming, or VLIW topologies; and so on. In embodiments, one or more processors 810 are coupled to the memory 812, wherein the one or more processors, when executing the instructions which are stored, are configured to: access an array of compute elements, wherein each compute element within the array of compute elements is known to a compiler and is coupled to its neighboring compute elements within the array of compute elements; provide control for the compute elements on a cycle-by-cycle basis, wherein control is enabled by a stream of wide control words generated by the compiler; initialize a plurality of compute elements within the array of compute elements with a switch statement, wherein the switch statement is mapped into a primitive operation in each element of the plurality of compute elements, and wherein the initializing is based on a control word from the stream of control words; execute each of the primitive operations in an architectural cycle; and return a result for the switch statement, wherein the returning is determined by a decision variable. The stream of wide control words can include a plurality of compressed control words. The plurality of compressed control words is decompressed by hardware associated with the array of compute elements and is driven into the array. The plurality of compressed control words is decompressed into fixed-length control words that comprise one or more compute element operations. The compute element operations are executed within the array of compute elements. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 800 can include a cache 820. The cache 820 can be used to store data such as a switch statement mapped into a primitive operation in each element of the compute element array. In embodiments, the mapping in each element of the plurality of compute elements comprises a spatially adjacent mapping. The cache can further be used to store precedence information; directions to compute elements; decompressed, fixed-length control words; compute element operations associated with decompressed control words; intermediate results; microcode; branch decisions; and so on. The cache can comprise a small, local, easily accessible memory available to one or more compute elements. The data that is stored within the cache can include the precedence information which enables hardware ordering of memory access loads to the array of compute elements and memory access stores from the array of compute elements. The precedence information can provide semantically correct operation ordering. The data that is stored within the cache can further include linking information; compressed control words; decompressed, fixed-length control words; etc. Embodiments include storing relevant portions of a control word within the cache associated with the array of compute elements. The cache can be accessible to one or more compute elements. The cache, if present, can include a dual read, single write (2R1 W) cache. That is, the 2R1 W cache can enable two read operations and one write operation contemporaneously without the read and write operations interfering with one another. The cache can be coupled to operate in cooperation with, etc. scratchpad storage. The scratchpad storage can include a small, fast, local memory element coupled to one or more compute elements. In embodiments, the scratchpad storage can act as a “level zero” or L0 cache within a multi-level cache storage hardware configuration.

The system 800 can include an accessing component 830. The accessing component 830 can include control logic and functions for accessing an array of compute elements. Each compute element within the array of compute elements is known to a compiler and is coupled to its neighboring compute elements within the array of compute elements. A compute element can include one or more processors, processor cores, processor macros, and so on. Each compute element can include an amount of local storage. The local storage may be accessible to one or more compute elements. Each compute element can communicate with neighbors, where the neighbors can include nearest neighbors or more remote “neighbors”. Communication between and among compute elements can be accomplished using a bus such as an industry standard bus, a ring bus, vertical buses, horizontal buses, a network such as a wired or wireless computer network, etc. In embodiments, the bus is implemented as a distributed multiplexor (MUX).

The system 800 can include a providing component 840. The providing component 840 can include control and functions for providing control for the compute elements on a cycle-by-cycle basis, wherein control is enabled by a stream of wide control words generated by the compiler. The plurality of control words enables compute element configuration and operation execution; compute element memory access; inter-compute element communication, etc., on a cycle-by-cycle basis. The control words can further include variable bit-length control words, compressed control words, and so on. The control words can be based on low-level control words such as assembly language words, microcode words, firmware words, and so on. In embodiments, the stream of wide, variable length control words generated by the compiler provides direct fine-grained control of the 2D array of compute elements. The compute operations can include a read-modify-write operation. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. The control can enable machine learning functionality for the neural network topology.

The control of the array of compute elements on a cycle-by-cycle basis can include configuring the array to perform various compute operations. In embodiments, the stream of wide control words generated by the compiler provides direct fine-grained control of the 2D array of compute elements. The fine-grained control can include individually controlling each compute element, irrespective of the type of compute element. A compute element type can include an integer, floating-point, address generation, write buffer, or read buffer element, etc. The compute operations can include a read-modify-write operation. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies, such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a network topology such as a neural network topology, a Petri Net topology, etc. A control can enable machine learning functionality for the neural network topology.

In embodiments, the control word from the stream of wide control words can include a source address, a target address, a block size, and a stride. The target address can include an absolute address, a relative address, an indirect address, and so on. The block size can be based on a logical block size, a physical memory block size, and the like. In embodiments, the memory block transfer control logic can compute memory addresses. The memory addresses can be associated with memory coupled to the 2D array of compute elements, shared memory, a memory system, etc. Further embodiments can include using memory block transfer control logic. The memory block transfer control logic can include one or more dedicated logic blocks, configurable logic, etc. In embodiments, the memory block transfer control logic can be implemented outside of the 2D array of compute elements. The transfer control logic can include a logic element coupled to the 2D array. In other embodiments, the memory block transfer control logic can operate autonomously from the 2D array of compute elements. In a usage example, a control word that includes a memory block transfer request can be provided to the memory block transfer control logic. The logic can execute the memory block transfer while the 2D array of compute elements is processing control words, executing compute element operations, and the like. In other embodiments, the memory block transfer control logic can be augmented by configuring one or more compute elements from the 2D array of compute elements. The compute elements from the 2D array can provide interfacing operations between compute elements within the 2D array and the memory block transfer control logic. In other embodiments, the configuring can initialize compute element operation buffers within the one or more compute elements. The compute element operation buffers can be used to buffer control words, decompressed control words, portions of control words, etc. In further embodiments, the operation buffers can include bunch buffers. Control words are based on bits. Sets of control word bits called bunches can be loaded into buffers called bunch buffers. The bunch buffers are coupled to compute elements and can control the compute elements. The control word bunches are used to configure the 2D array of compute elements, and to control the flow or transfer of data within and the processing of the tasks and subtasks on the compute elements within the array.

The control words that are generated by the compiler can further include a conditionality such as a branch. In embodiments, the control words can include branch operations. The branch can include a conditional branch, an unconditional branch, etc. The control words can be decompressed by a decompressor logic block that decompresses words from a compressed control word cache on their way to the array. In embodiments, the set of directions can include a spatial allocation of subtasks on one or more compute elements within the array of compute elements. In other embodiments, the set of directions can enable multiple, simultaneous programming loop instances circulating within the array of compute elements. The multiple programming loop instances can include multiple instances of the same programming loop, multiple programming loops, etc.

The system block diagram 800 can include an initializing component 850. The initializing component 850 can include control and functions for initializing a plurality of compute elements within the array of compute elements with a switch statement. The initializing the compute elements can include allocating compute elements, configuring or scheduling the compute elements, and so on. The switch statement is mapped into a primitive operation in each element of the plurality of compute elements. A primitive operation can include an arithmetic operation such as addition and subtraction; a logical operation such as AND, OR, NAND, NOR, NOT, XOR, and XNOR; data operations such as load and store operations; etc. The initializing is based on a control word from the stream of control words. The initializing can be accomplished using one or more control words from the stream of wide control words provided on a cycle-by-cycle basis. The control words are generated by the compiler. In embodiments, the mapping in each element of the plurality of compute elements comprises a spatially adjacent mapping. The spatially adjacent mapping can include pairs or quads of compute elements, regions within the array, array quadrants, and the like. In embodiments, the spatially adjacent mapping can include an M×N subarray of the array of compute elements. The M×N array can be configured in various orientations such as vertical (M>N), horizontal (M<N), square (M+N), etc. In embodiments, the M×N subarray includes non-primitive mapped compute elements.

The system 800 can include an executing component 860. The executing component 860 can include control and functions for executing each of the primitive operations in an architectural cycle. A switch statement can be broken down into switch blocks, one or more cases, a default, and so on. The switch statement can be evaluated based on an expression, and the cases can perform operations such as primitive operations based on a value associated with the expression. In the event that none of the cases match the value associated with the expression, then one or more operations associated with a default case can be executed. In embodiments, each of the cases associated with the switch block can be executed substantially in parallel. The substantially parallel execution of the cases occurs within the architectural cycle. Primitive operations related to the cases associated with the switch block can begin execution prior to the switch case evaluation decision being made. When the case decision is made, then further operations associated with the taken case can be executed while operations associated with the untaken cases can be halted. Further embodiments can include suppressing memory access stores for untaken cases. The suppressing memory access stores for the untaken cases can include ignoring the access stores, overwriting the access stores, and so on.

Memory access operations associated with the primitive operations can be monitored and controlled by a control unit. The control unit can further be used to control the array of compute elements on a cycle-by-cycle basis. The controlling can be enabled by the stream of wide control words generated by the compiler. The control words can be based on low-level control words such as assembly language words, microcode words, firmware words, and so on. The control words can be of variable length, such that a different number of operations for a differing plurality of compute elements can be conveyed in each control word. The control of the array of compute elements on a cycle-by-cycle basis can include configuring the array to perform various compute operations. In embodiments, the stream of wide control words comprises variable length control words generated by the compiler. In embodiments, the stream of wide, variable length control words generated by the compiler provides direct fine-grained control of the 2D array of compute elements. The compute operations can include a read-modify-write operation. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies, such as processing topologies, within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control word can enable machine learning functionality for the neural network topology.

The system 800 can include a returning component 870. The returning component 870 can include control and functions for returning a result for the switch statement, wherein the returning is determined by a decision variable. The decision variable can be used to determine which case associated with the switch block is the true case. The result that is returned can include a value such as an integer, real, or floating-point value. In embodiments, the result can be provided by one of the plurality of compute elements. The compute element can provide the result based on execution of the primitive operation associated with the compute element. Further embodiments include updating the decision variable. The decision variable can be updated based on evaluation of an operation such as an arithmetic or logical operation. In embodiments, the updating the decision variable can be based on an outcome of one of the primitive operations. The outcome can be based on the primitive operation associated with a portion of the switch block indicated by the decision variable. In embodiments, the outcome of one of the primitive operations can include a variable compare operation. The variable compare operation can compare a variable to a constant, to another variable, and so on. The variable compare operation can include an equality or an inequality such as A=B, A<B, A>B, etc. In embodiments, the variable compare operation can satisfy a case statement derived from the switch statement. In embodiments, the updating the decision variable can be accomplished by broadcasting the decision variable. The decision variable can be broadcast to compute elements within the array of compute elements.

Recall that control words generated by the compiler are provided to control the compute elements on a cycle-by-cycle basis. The control words can include uncompressed control words, compressed control words, and so on. Further embodiments include decompressing a plurality of compressed control words. The decompressing the compressed control words can include enabling or disabling individual compute elements, rows or columns of compute elements, regions of compute elements, and so on. The decompressed control words can include one or more compute element operations. Further embodiments include executing operations within the array of compute elements using the plurality of compressed control words that were decompressed. The order in which the operations are executed is critical to successful processing such as parallel processing. In embodiments, the decompressor can operate on compressed control words that were ordered before they are presented to the array of compute elements. The operations that can be performed can include arithmetic operations, Boolean operations, matrix operations, neural network operations, and the like. The operations can be executed based on the control words generated by the compiler. The control words can be provided to a control unit, where the control unit can control the operations of the compute elements within the array of compute elements. Operation of the compute elements can include configuring the compute elements, providing data to the compute elements, routing and ordering results from the compute elements, and so on. In embodiments, the same decompressed control word can be executed on a given cycle across the array of compute elements. The control words can be decompressed to provide control on a per compute element basis, where each control word can be comprised of a plurality of compute element control groups or bunches. One or more control words can be stored in a compressed format within a memory such as a cache. The compression of the control words can greatly reduce storage requirements. In embodiments, the control unit can operate on decompressed control words. The executing operations contained in the control words can include distributed execution of operations. In embodiments, the distributed execution of operations can occur in two or more compute elements within the array of compute elements. Recall that the mapping of the virtual registers can include renaming by the compiler. In embodiments, the renaming can enable the compiler to orchestrate execution of operations using the physical register files.

The system 800 can include a computer program product embodied in a non-transitory computer readable medium for parallel processing, the computer program product comprising code which causes one or more processors to perform operations of: accessing an array of compute elements, wherein each compute element within the array of compute elements is known to a compiler and is coupled to its neighboring compute elements within the array of compute elements; providing control for the compute elements on a cycle-by-cycle basis, wherein control is enabled by a stream of wide control words generated by the compiler; initializing a plurality of compute elements within the array of compute elements with a switch statement, wherein the switch statement is mapped into a primitive operation in each element of the plurality of compute elements, and wherein the initializing is based on a control word from the stream of control words; executing each of the primitive operations in an architectural cycle; and returning a result for the switch statement, wherein the returning is determined by a decision variable.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for parallel processing comprising:
accessing an array of compute elements, wherein each compute element within the array of compute elements is known to a compiler and is coupled to its neighboring compute elements within the array of compute elements;
providing control for the compute elements on a cycle-by-cycle basis, wherein control is enabled by a stream of wide control words generated by the compiler;
initializing a plurality of compute elements within the array of compute elements with a switch statement, wherein the switch statement is mapped into a primitive operation in each element of the plurality of compute elements, and wherein the initializing is based on a control word from the stream of control words;
executing each of the primitive operations in an architectural cycle; and
returning a result for the switch statement, wherein the returning is determined by a decision variable.

2. The method of claim 1 wherein the result is provided by one of the plurality of compute elements.

3. The method of claim 1 wherein the mapping in each element of the plurality of compute elements comprises a spatially adjacent mapping.

4. The method of claim 3 wherein the spatially adjacent mapping comprises an M×N subarray of the array of compute elements.

5. The method of claim 4 wherein the M×N subarray includes non-primitive mapped compute elements.

6. The method of claim 3 wherein the spatially adjacent mapping is determined at compile time by the compiler.

7. The method of claim 1 wherein the decision variable is loaded into the plurality of compute elements from a data cache.

8. The method of claim 1 wherein the decision variable is provided to the compute elements by the control word.

9. The method of claim 1 further comprising updating the decision variable.

10. The method of claim 9 wherein the updating the decision variable is based on a load into the array of compute elements from a data cache.

11. The method of claim 9 wherein the updating the decision variable is based on an outcome of one of the primitive operations.

12. The method of claim 11 wherein the outcome of one of the primitive operations comprises a variable compare operation.

13. The method of claim 12 wherein the variable compare operation satisfies a case statement derived from the switch statement.

14. The method of claim 9 wherein the updating the decision variable is accomplished by broadcasting the decision variable.

15. The method of claim 14 wherein the broadcasting occurs along a horizontal bus.

16. The method of claim 15 wherein the mapping in each element of the plurality of compute elements is performed by the compiler to minimize broadcasting along the bus that carries data cache traffic.

17. The method of claim 14 wherein the broadcasting occurs along a bus that carries data cache traffic.

18. The method of claim 17 wherein the mapping in each element of the plurality of compute elements is performed by the compiler to minimize broadcasting along the bus that carries data cache traffic.

19. The method of claim 9 wherein the updating the decision variable is based on the result that was returned.

20. The method of claim 19 wherein the result that was returned comprises successful completion of the executing.

21. The method of claim 1 further comprising delaying the returning a result, based on at least one of the primitive operations requiring more than one architectural cycle.

22. The method of claim 21 wherein the delaying is based on the decision variable.

23. The method of claim 21 wherein the decision variable is propagated within the architectural cycle.

24. A computer program product embodied in a non-transitory computer readable medium for parallel processing, the computer program product comprising code which causes one or more processors to perform operations of:
accessing an array of compute elements, wherein each compute element within the array of compute elements is known to a compiler and is coupled to its neighboring compute elements within the array of compute elements;
providing control for the compute elements on a cycle-by-cycle basis, wherein control is enabled by a stream of wide control words generated by the compiler;
initializing a plurality of compute elements within the array of compute elements with a switch statement, wherein the switch statement is mapped into a primitive operation in each element of the plurality of compute elements, and wherein the initializing is based on a control word from the stream of control words;
executing each of the primitive operations in an architectural cycle; and
returning a result for the switch statement, wherein the returning is determined by a decision variable.

25. A computer system for parallel processing comprising:
a memory which stores instructions;
one or more processors coupled to the memory, wherein the one or more processors, when executing the instructions which are stored, are configured to:
access an array of compute elements, wherein each compute element within the array of compute elements is known to a compiler and is coupled to its neighboring compute elements within the array of compute elements;
provide control for the compute elements on a cycle-by-cycle basis, wherein control is enabled by a stream of wide control words generated by the compiler;
initialize a plurality of compute elements within the array of compute elements with a switch statement, wherein the switch statement is mapped into a primitive operation in each element of the plurality of compute elements, and wherein the initializing is based on a control word from the stream of control words;
execute each of the primitive operations in an architectural cycle; and
return a result for the switch statement, wherein the returning is determined by a decision variable.
